(19) United States
(12) Patent Application Publication
(10) Pub. No.: US 2023/0250634 A1
(43) Pub. Date: Aug. 10, 2023

(54) FIRE-RESISTANT WALL ASSEMBLY

(71) Applicant: LOUISIANA-PACIFIC CORPORATION, Nashville, TN (US)

(72) Inventor: SCOTT JOHNSON, PORTLAND, OR (US)

(21) Appl. No.: 18/106,415

(22) Filed: Feb. 6, 2023

Related U.S. Application Data
(60) Provisional application No. 63/306,671, filed on Feb. 4, 2022.
(60) Provisional application No. 63/309,721, filed on Feb. 14, 2022.
(60) Provisional application No. 63/319,669, filed on Mar. 14, 2022.
(60) Provisional application No. 63/433,462, filed on Dec. 18, 2022.

(51) Int. Cl. E04B 2/74

(52) U.S. Cl. CPC E04B 2/7411; E04B 2/7414

(57) ABSTRACT

A multi-component fire-resistant (FR) assembly for use in various forms of construction. The FR assembly attains 30 minutes, 1-hour, 2-hour, or 3-hour fire resistance from either side (in accordance with ASTM E119 criteria), and does not require any added FR panels or sheathing. The FR assembly comprises an interior layer, a plurality of supporting studs, an exterior layer, a weather-resistant barrier (WRB) layer, and, in some embodiments, an outer layer. The placement of the studs creates a cavity or cavities between the interior layer and the exterior layer, which may be filled with an insulating or similar material.

This application claims benefit of and priority to U.S. Provisional Applications No. 63/306,671, filed Feb. 4, 2022, No. 63/309,721, filed Feb. 14, 2022, No. 63/319,669, filed Mar. 14, 2022, and No. 63/433,462, filed Dec. 18, 2022, all of which are incorporated herein in their entireties by specific reference for all purposes.

### FIELD OF INVENTION

This invention relates to a fire-resistant rated wall assembly. More particularly, this invention relates to a fire-resistant wall assembly with 30-minute to 3-hour fire resistance ratings, in accordance with ASTM E119 standard criteria.

### BACKGROUND OF THE INVENTION

Building wall, floor and roof assemblies are typically layers of several materials, each performing a single function, that are installed separately on the site or prefabricated offsite in which the building is being constructed. Compatibility between the various layers creates challenges not only for the designer, but also for the installers. Examples of interior and exterior wall assemblies are disclosed in U.S. Pat. No. 4,854,096 (issued Aug. 8, 1989), and U.S. Pat. No. 8,001,736 (issued Aug. 23, 2011), both of which are incorporated herein in their entireties by specific reference for all purposes.

A typical layer in most such assembles is gypsum panels or a wood panel product, or an integral composite engineered panel product, including, but not limited to, engineered wood composite products. Wood-based composites have been found to be acceptable alternatives in most cases to of wood paneling, sheathing and decking lumber. In general, wood-based composites include plywood, particle board, oriented strand board (OSB), wafer board, as well as medium density fiberboard (MDF), with the wood-based composites typically formed from a wood material combined with a thermosetting adhesive to bind the wood substrate together. Often times, the adhesive is combined with other additives to impart additional properties to the wood composites. Additives can include fire retardants, insect repellants, water repellents, preservatives, and color dyes. A significant advantage of wood-based composites is that they have many of the properties of plywood, but can be made from lower grade wood species and waste from other wood product production, and can be formed into panels in lengths and widths independent of size of the harvested timber.

A major reason for increased presence in the marketplace of the above-described product alternatives to natural solid wood lumber is that these materials exhibit properties like those of the equivalent natural solid wood lumber, especially, the properties of retaining strength, durability, stability and finish under exposure to expected environmental and use conditions. A class of alternative products are multilayer oriented wood strand particleboards, particularly those with a layer-to-layer oriented strand pattern, such as OSB. Oriented, multilayer wood strand boards are composed of several layers of thin wood strands, which are wood particles having a length which is several times greater than their width. These strands are formed by slicing larger wood pieces so that the fiber elements in the strands are substantially parallel to the strand length. The strands in each layer are positioned relative to each other with their length in substantial parallel orientation and extending in a direction approaching a line which is parallel to one edge of the layer. The layers are positioned relative to each other with the oriented strands of adjacent layers perpendicular, forming a layer-to-layer cross-oriented strand pattern. Oriented, multilayer wood strand boards of the above-described type, and examples of processes for pressing and production thereof, are described in detail in U.S. Pat. No. 3,164,511, U.S. Pat. No. 4,364,984, U.S. Pat. No. 5,435,976, US. Pat. No. 5,470,631, U.S. Pat. No. 5,525,394, U.S. Pat. No. 5,718,786, and U.S. Pat. No. 6,461,743, all of which are incorporated herein in their entireties by specific reference for all purposes.

Certain oriented board products can be made from flakes that are created from debarked round logs by placing the edge of a cutting knife parallel to a length of the log and the slicing thin flakes from the log. The cut flakes are subjected to forces that break the flakes into strands having a length parallel to the grain of the wood several times the width of the strand. The strands can be oriented on the board-forming machine with the strands predominantly oriented in a single (e.g., cross-machine) direction in one (e.g., core) layer and predominantly oriented in the generally perpendicular (machine) direction in adjacent layers. The various layers are bonded together by natural or synthetic resins under heat and pressure to make the finished product. Oriented, multilayer wood strand boards of the above-described type are produced with bending, tensile strengths and face strengths comparable to those of commercial softwood plywood.

Building wall, floor and roof assemblies typically are constructed by attaching several panels of the above-described type as to an underlying supporting structure frame as “sheathing.” These sheathing panels are often placed in a pattern forming a substantially continuous flat surface. In certain types of construction, the panels (and other construction materials) may be required under applicable building codes to meet certain fire resistance or water resistance requirements.

For certain applications and/or locations, panels or panel assemblies are required to meet certain fire resistance ratings under applicable codes (i.e., Fire-Rated sheathing). Fire ratings indicates that the panel assembly is built to withstand the heat from a fire for a certain period of time before failing. Typical fire ratings are referred to as one and two hour ratings (or other appropriate time periods). According to the Engineered Wood Association, for example, a one-hour rating indicates that a wall constructed in a manner similar to the one tested will contain flames and high temperatures, and support its full load for at least one hour after the fire begins. Thus, for example, a Fire-Rated OSB sheathing may be used as a component in a 1-hour and/or 2-hour UL-listed (Underwriter Laboratories) fire-rated wall assembly.

In prior art applications, a fire-retardant-treated (FRT) panel is installed as sheathing at a job or construction site. However, FRT lumber or plywood panels are prone to chemical leaching, and therefore need to be kept dry after installation, and otherwise withstand short-term weather exposure during construction.

Accordingly, what is needed is a wood or wood composite product panel that provides fire resistance and a protective layer to significantly reduce the leaching of fire-retardant during and after construction, without the need for a (water or weather resistant barrier) WRB system applied at the job or construction site.\

### SUMMARY OF THE INVENTION

In various exemplary embodiments, the present invention comprises a multicomponent fire-resistant (FR) assembly for use in various forms of construction. The FR assembly attains 30 minutes, 1-hour, 2-hour, or 3-hour fire resistance from either side (in accordance with ASTM E119 criteria), and does not require any added FR panels or sheathing.

In several embodiments, the FR assembly comprises an interior layer, a plurality of supporting studs, an exterior layer, a weather-resistant barrier (WRB) layer, and, in some embodiments, an outer layer. In the embodiment shown, the placement of the studs creates a cavity between the interior layer and the exterior layer. The cavity typically may be filled with an insulating or similar material.

The interior layer and exterior layer typically are fastened to the studs by nails, screws, or similar fastening means. The WRB layer typically is fastened to the exterior layer by nails, screws, staples, tape, adhesive, lamination, bonding, or similar fastening means. Outer layer(s) typically are fastened to the interior layer by nails, screws, or the other attachment means described above. In several embodiments, the fasteners extend through the exterior layer into the studs.

The interior layer is disposed on the inside of the assembly facing the interior of the building or structure. It may comprise gypsum (e.g., ⅝″ type X gypsum), stucco, plaster, wood, wood composite, engineered wood, or similar material, or combinations thereof. In some embodiments, the interior layer also may comprise a structural panel, such as, but not limited to, e.g., an engineered-wood panel, an oriented strand-board (OSB) panel, or a CDX plywood panel, in conjunction with these materials.

The studs may comprise wood or metal studs. The cavity-filling material may comprise, but is not limited to, batt insulation (e.g., fiberglass, mineral wool or mineral wool products), foam, close-cell or open-cell foam, cellulose, or blown-in insulation. Mineral wool (also referred to as mineral fiber, mineral cotton, mineral fiber, alkaline earth silicate wool, alumino silicate wool, polycrystalline woo, kaowool, man-made mineral fiber, and man-made vitreous fiber) is any fibrous material formed by spinning or drawing molten material or rock or stone material, including, but not limited to, slag and ceramics. Mineral wool products for purposes of this application include, but are not limited to, mineral wool rolls, mineral wool sheets, mineral board, mineral wool board, mineral fiber board, mineral bonded wood wool board, ceramic fiber board, resin-bonded panels, stone wool, glass wool, and slag wool. In some embodiments, the cavity may be left unfilled (i.e., no insulation).

The exterior layer may comprise a wood or structural wood-composite panel, such as an OSB panel or CDX plywood panel. It also may comprise a metal panel or sheet, or other form of panel.

The WRB layer may comprise a polymeric sheeting or “housewrap” material, or may be integrated with the exterior layer, such as a resin-impregnated kraft paper overlay that is bonded to the exterior layer by heat and pressure by a primary pressing process during formation, or through a second pressing process. Alternative forms of the WRB layer include, but are not limited to, a liquid or fluid-applied WRB, a closed-cell foam, or a polymer film.

The outer layer may comprise a form of cladding, siding (e.g., lap, panel, shake, or the like), stucco, brick, masonry, stone, metal, vinyl, wood, engineered wood, fiber cement, or the like. This typically is the outermost layer on a structure.

In several embodiments, however, the exterior layer and/or the outer layer may also comprise some form of insulation material, such as, but not limited to, foam-board, mineral wool, mineral board, or various mineral wool products. As described above, mineral wool products for purposes of this application include, but are not limited to, mineral wool rolls, mineral wool sheets, mineral board, mineral wool board, mineral fiber board, mineral bonded wood wool board, ceramic fiber board, resin-bonded panels, stone wool, glass wool, and slag wool.

In a further embodiment, one or more insulation layer(s) may be added between the exterior layer and the WRB layer, between the exterior layer and the outer layer, and/or between the WRB layer and the outer layer. The insulation layer may comprise some form of insulation material, such as, but not limited to, foam-board, mineral wool, mineral board, or various mineral wool products. As described above, mineral wool products for purposes of this application include, but are not limited to, mineral wool rolls, mineral wool sheets, mineral board, mineral wool board, mineral fiber board, mineral bonded wood wool board, ceramic fiber board, resin-bonded panels, stone wool, glass wool, and slag wool.

### BRIEF DESCRIPTION OF THE DRAWINGS

FIG. 1 shows a perspective cutaway view of a fire-resistant assembly in accordance with the present invention.

FIGS. 2-10 shows side cutaway views of various embodiments of a fire-resistant assembly.

### BRIEF DESCRIPTION OF INVENTION

In various exemplary embodiments, the present invention comprises a multicomponent fire-resistant (FR) assembly 2 for use in various forms of construction. The FR assembly attains 30 minutes, 1-hour, 2-hour, or 3-hour fire resistance from either side (in accordance with applicable ASTM E119 criteria, as updated from time to time), and does not require any added FR panels or sheathing.

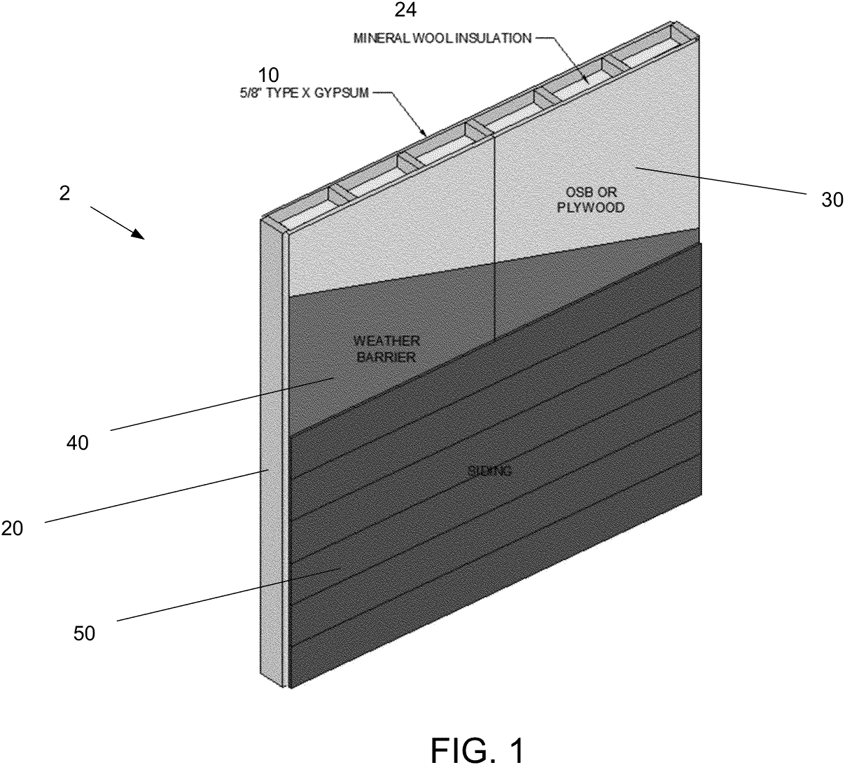

As seen in FIG. 1, the FR assembly 2 comprises an interior layer 10, a plurality of supporting studs 20, an exterior layer 30, a weather-resistant barrier (WRB) layer 40, and, in some embodiments, an outer layer 50. In the embodiment shown, the placement of the studs 20 creates a cavity 22 between the interior layer and the exterior layer. The cavity typically may be filled with an insulating or similar material 24.

The interior layer and exterior layer typically are fastened to the studs by nails, screws, or similar fastening means. The WRB layer 40 typically is fastened to the exterior layer 30 by nails, screws, staples, tape, adhesive, lamination, bonding, or similar fastening means. Outer layer(s) 50 typically are fastened to the interior layer by nails, screws, or the other attachment means described above. In several embodiments, the fasteners extend through the exterior layer 30 into the studs.

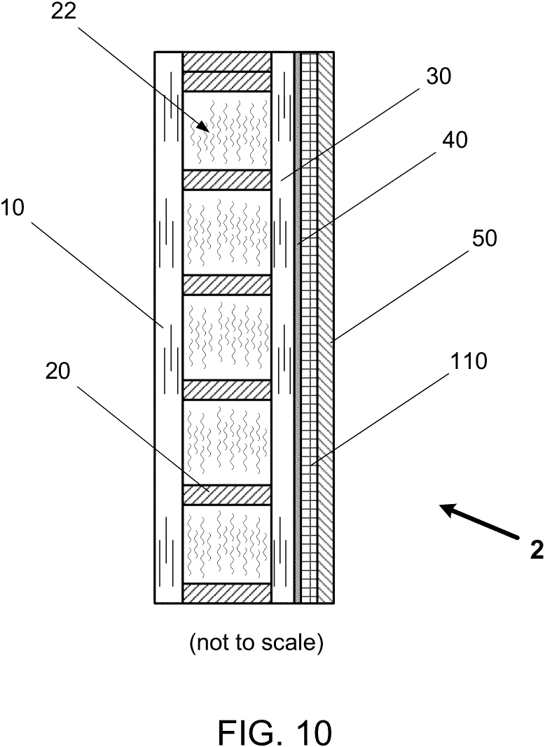

The interior layer 10 is disposed on the inside of the assembly facing the interior of the building or structure. It may comprise gypsum (e.g., ⅝″ type X gypsum), stucco, plaster, wood, wood composite, engineered wood, or similar material, or combinations thereof. In some embodiments, the interior layer 10 also may comprise a structural panel, such as, but not limited to, e.g., an engineered-wood panel, an oriented strand-board (OSB) panel, or a CDX plywood panel, in conjunction with these materials. FIG. 10 shows an assembly where the interior layer 10 and the exterior layer 20 both comprise the same material, e.g., a wood panel or structural wood-composite panel.

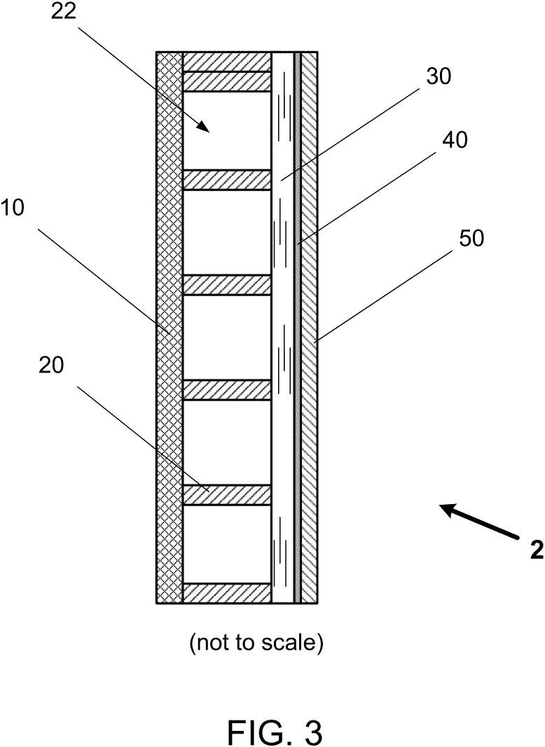

The studs 20 may comprise wood or metal studs. The cavity-filling material 24 may comprise, but is not limited to, batt insulation (e.g., fiberglass, mineral wool or mineral wool products), foam, close-cell or open-cell foam, cellulose, or blown-in insulation. Mineral wool (also referred to as mineral fiber, mineral cotton, mineral fiber, alkaline earth silicate wool, alumino silicate wool, polycrystalline woo, kaowool, man-made mineral fiber, and man-made vitreous fiber) is any fibrous material formed by spinning or drawing molten material or rock or stone material, including, but not limited to, slag and ceramics. Mineral wool products for purposes of this application include, but are not limited to, mineral wool rolls, mineral wool sheets, mineral board, mineral wool board, mineral fiber board, mineral bonded wood wool board, ceramic fiber board, resin-bonded panels, stone wool, glass wool, and slag wool. In some embodiments, the cavity 22 may be left unfilled (i.e., no insulation), as seen FIGS. 3-6. Each configuration in a figure showing a configuration with the cavity filled can be constructed as an alternative configuration with the cavity left unfilled, and vice versa.

The exterior layer 30 may comprise a wood or structural wood-composite panel, such as an OSB panel or CDX plywood panel. It also may comprise a metal panel or sheet, or other form of panel.

The WRB layer 40 may comprise a polymeric sheeting or “housewrap” material, or may be integrated with the exterior layer 30, such as a resin-impregnated kraft paper overlay that is bonded to the exterior layer by heat and pressure by a primary pressing process during formation, or through a second pressing process. Alternative forms of the WRB layer include, but are not limited to, a liquid or fluid-applied WRB, a closed-cell foam, or a polymer film.

The outer layer 50 may comprise a form of cladding, siding (e.g., lap, panel, shake, or the like), stucco, brick, masonry, stone, metal, vinyl, wood, engineered wood, fiber cement, or the like. This typically is the outermost layer on a structure.

In several embodiments, however, the exterior layer 30 and/or the outer layer 50 may also comprise some form of insulation material, such as, but not limited to, foam-board, mineral wool, mineral board, or various mineral wool products. As described above, mineral wool products for purposes of this application include, but are not limited to, mineral wool rolls, mineral wool sheets, mineral board, mineral wool board, mineral fiber board, mineral bonded wood wool board, ceramic fiber board, resin-bonded panels, stone wool, glass wool, and slag wool.

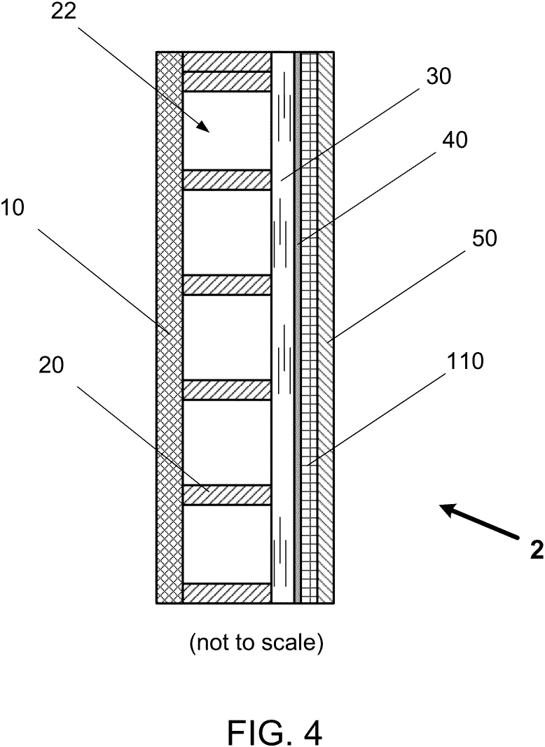

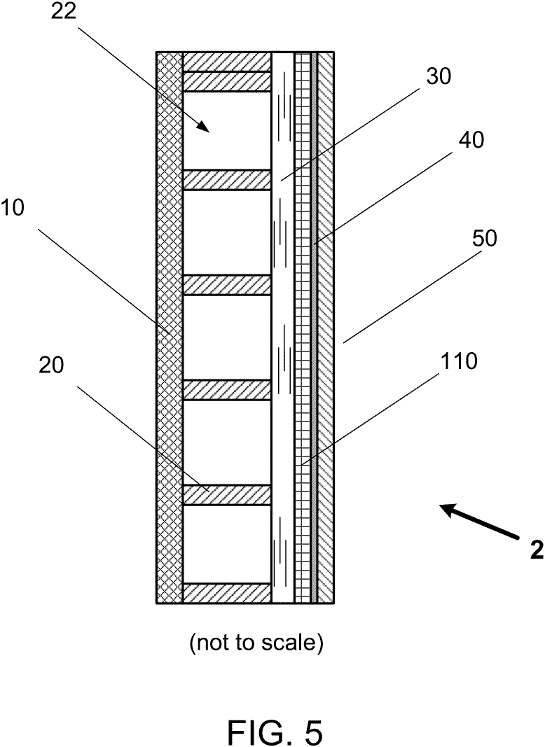

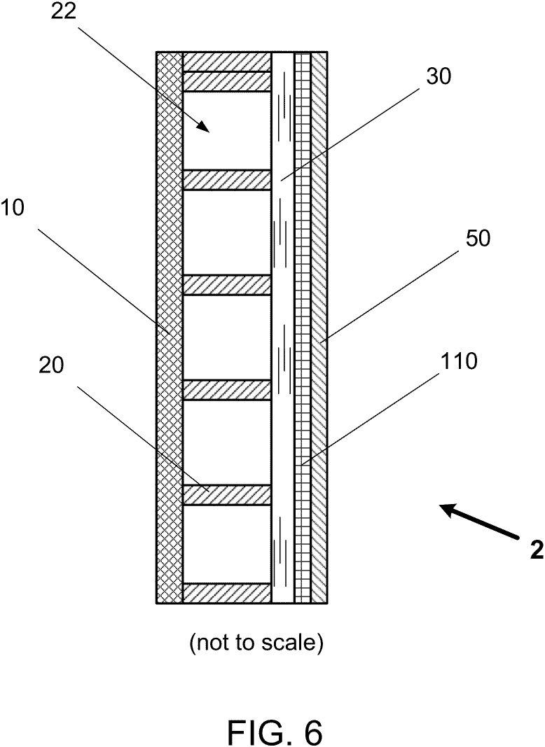

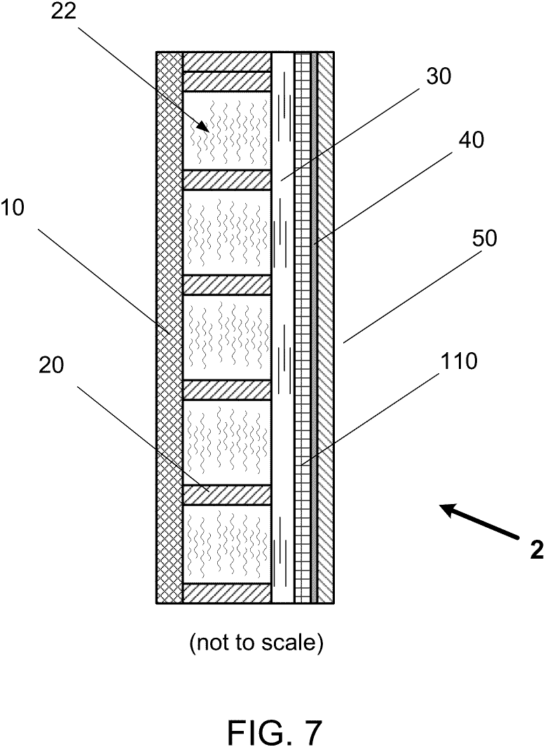

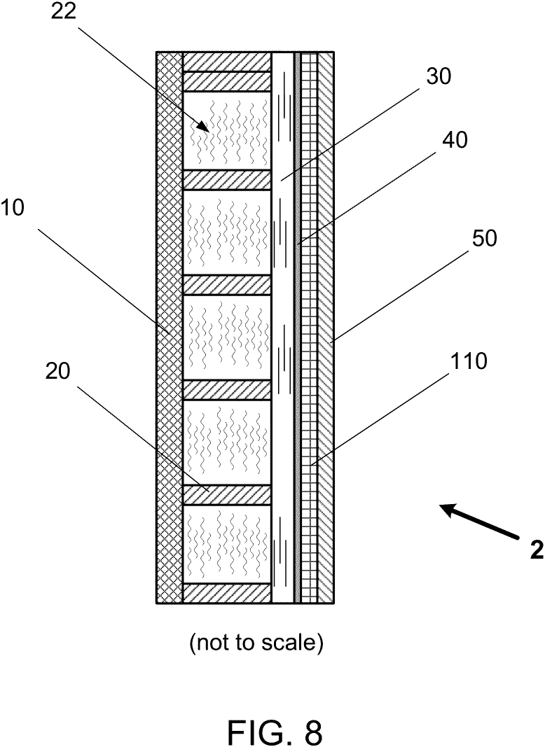

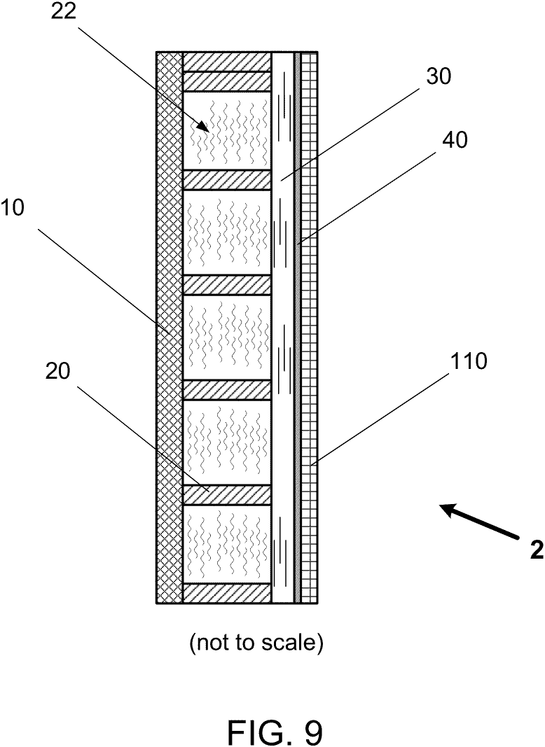

In a further embodiment, one or more insulation layer(s) 110 may be added between the exterior layer and the WRB layer (see FIG. 4), between the exterior layer and the outer layer (see FIGS. 6 and 8), and/or between the WRB layer and the outer layer (see FIGS. 5 and 7). The insulation layer may comprise some form of insulation material, such as, but not limited to, foam-board, mineral wool, mineral board, or various mineral wool products. In some embodiments, the insulation layer 110 may be the outermost layer of the assembly, as shown in FIG. 9. As described above, mineral wool products for purposes of this application include, but are not limited to, mineral wool rolls, mineral wool sheets, mineral board, mineral wool board, mineral fiber board, mineral bonded wood wool board, ceramic fiber board, resin-bonded panels, stone wool, glass wool, and slag wool.

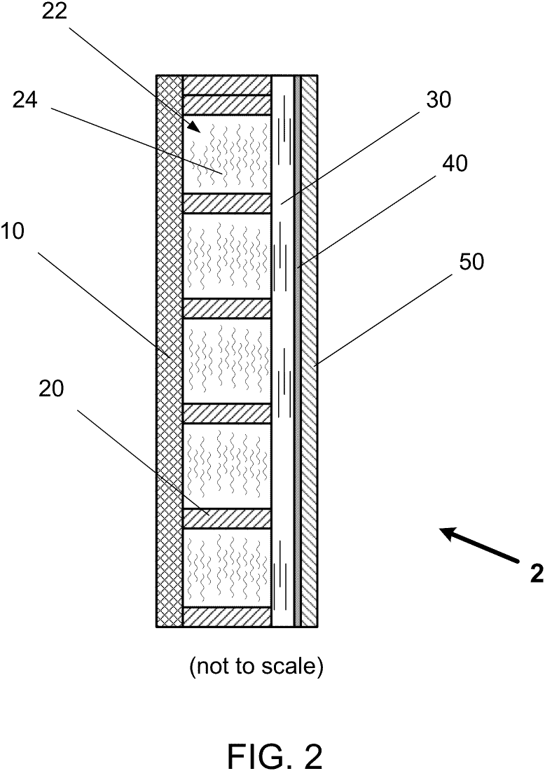

FIGS. 1 and 2 show one exemplary embodiment of an FR assembly 2. The interior layer 10 is a ⅝″ thick interior type X gypsum panel, secured to the studs using 8d drywall nails spaced 8 in. on center on the perimeter of the panel, and across the middle face (i.e., “in the field”) of the panel. The studs 20 are 2×6″ wood studs, vertically spaced at 16 inches. The top plate is constructed from two wood studs installed horizontally at the top of the assembly, and the bottom plate is a single wood stud. The cavities 22 are filled with mineral wool or mineral wool products insulation 24 (e.g., nominal 5.5 inch thick, nominal 2.8 lb/cu. ft. density, unfaced mineral wool insulation friction fit between the studs). The exterior layer 30 is a 7/16″ thick OSB or plywood structural panel (in the embodiment show, nominal 48 inches width and 12 inches tall), with an integrated WRB (weather-resistant barrier) layer 40, such as, but not limited to, a resin-impregnated paper overlay pre-attached to a face of the exterior layer panel(s) during a manufacturing process. The exterior layer and integrated WRB layer are secured to the studs with 6d nails spaced 6 in. on center on the perimeter, and spaced 12 in. on center across the middle face of the panel, with ½ inch at joint edges. The outer layer is a minimum ⅜ in. thick wood-based exterior panel siding 50 (such as, but not limited to, LP SmartSide Lap, Shake or Panel siding).

FIG. 3 shows the alternative configuration of FIG. 2, with the cavities 22 left unfilled.

The FR assembly in several embodiments is unique in that it only requires the exterior siding 30, WRB layer 40, and exterior layer 50 to achieve the appropriate FR rating. It does not require any additional exterior gypsum, FR panels, non-combustible materials, or FR coatings.

In other embodiments, the FR assembly is unique in that it requires only an exterior insulation layer 110 over the WRB layer 40 and exterior panel 30 to achieve the appropriate FR rating.

The FR assembly as described herein thus provides a building-code-approved product that provides structural performance and fire resistance characteristics for use in wall, floor and roof applications that require a fire resistance performance, such as residential, single- or multi-family, light framed mid-rise and commercial construction.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A fire-resistant wall assembly, comprising:
an interior panel with an inner face and an outer face;
an exterior panel with an inner face and an outer face;
a plurality of studs located between the interior panel and exterior panel, and affixed to the outer face of the interior panel and the inner face of the exterior panel; and
an outer panel disposed on an exterior face of the wall assembly.

2. The wall assembly of claim 1, wherein the outer panel comprises exterior cladding or siding.

3. The wall assembly of claim 1, wherein the outer panel comprises mineral board, mineral wool board, mineral fiber board, or mineral bonded wood wool board.

4. The wall assembly of claim 1, further comprising a WRB layer affixed to the outer face of the exterior panel.

5. The wall assembly of claim 4, wherein the WRB layer comprises a polymer-based sheet.

6. The wall assembly of claim 4, wherein the WRB layer comprises a resin-impregnated paper overlay.

7. The wall assembly of claim 1, further comprising a plurality of cavities between the plurality of studs.

8. The wall assembly of claim 7, wherein one or more of the plurality of cavities contain insulation material.

9. The wall assembly of claim 1, further comprising an insulation layer disposed between the exterior panel and the outer panel.

10. The wall assembly of claim 9, wherein the insulation layer comprises mineral board, mineral wool board, mineral fiber board, or mineral bonded wood wool board.

11. The wall assembly of claim 1, wherein the interior panel comprises gypsum board.

12. The wall assembly of claim 1, wherein the exterior panel comprises an OSB panel.

13. The wall assembly of claim 1, wherein the interior panel comprises an engineered-wood panel.

14. The wall assembly of claim 13, wherein the interior panel comprises an OSB panel.

15. A fire-resistant wall assembly, comprising:
an interior panel with an inner face and an outer face;
an exterior panel with an inner face and an outer face;
a plurality of studs located between the interior panel and exterior panel, and affixed to the outer face of the interior panel and the inner face of the exterior panel;
wherein the exterior panel comprises mineral board, mineral wool board, mineral fiber board, or mineral bonded wood wool board.
